(19) United States
(12) Patent Application Publication
(10) Pub. No.: US 2014/0222737 A1
(43) Pub. Date: Aug. 7, 2014

(54) System and Method for Developing Proxy Models

(71) Applicant: Opera Solutions, LLC, Jersey City, NJ (US)

(72) Inventors: Yonghui Chen, San Diego, CA (US); Mona Mahmoudi, San Diego, CA (US)

(73) Assignee: OPERA SOLUTIONS, LLC, Jersey City, NJ (US)

(21) Appl. No.: 14/171,384

(22) Filed: Feb. 3, 2014

Related U.S. Application Data
(60) Provisional application No. 61/759,682, filed on Feb. 1, 2013.

(51) Int. Cl. G06N 99/00

(52) U.S. Cl. CPC G06N 99/005
USPC 706/12

(57) ABSTRACT

A system and method for developing proxy models is provided. The system for developing proxy models comprising a proxy model development computer system in electronic communication with a training database storing training data therein, and a plurality of computer models including a complex model and a proxy model that are trained by the computer system using the training data from the training database, wherein the computer system evaluates performance of each of the plurality of computer models, and if the computer system determines that the proxy model at least meets pre-defined performance criteria and approximates performance of the complex model, then the computer system communicates to a user that the proxy model can substitute the complex model.

### CROSS-REFERENCE TO RELATED APPLICATION

This application claims priority to U.S. Provisional Patent Application No. 61/759,682 filed on Feb. 1, 2013, which is incorporated herein in its entirety by reference and made a part hereof.

### BACKGROUND OF THE INVENTION

1. Field of the Invention

The present invention relates generally to the field of computer modeling. More specifically, the present invention relates to a system and method for developing proxy models for use in various applications, such as modeling credit and underwriting risk.

2. Related Art

In various fields of endeavor, computer models are powerful tools that can be used to simulate real-world events. In particular, computer models are often used in the financial sector to model risks of various kinds, such as credit and underwriting risks. Such models can be very computationally complex, and often require numerous input variables.

In the credit and risk modeling field (such as in connection with underwriting), clients often demand high-performance models which satisfy constraints including limited numbers of input variables, explainable scores, and robustness. To satisfy such constraints, it is extremely challenging to build high-performance models with a limited number of input variables. Moreover, in many business areas, high score reason codes are needed for non-linear models (such as neural network models, random forest models, or ensemble models). One example is a loan application where a reason for rejecting a loan must be clear, but some input fields/variables that would ordinarily be provided to a complex computer model are not allowed by law. Another example is insurance pricing where an insurance rate must be explainable.

There are existing ways to boost the performance of computer models, such as adaptive boosting and bagging. There are also existing ways to approximate reason codes using computer models, such as binning methods. However, there exists a need to develop simpler (proxy) models which can be used in place of complex models, can be used reliably with limited input variables, and produce results which approach or even meet the performance standards of complex computer models.

### SUMMARY OF THE INVENTION

The present disclosure relates to a system and method for developing proxy models for computer systems. The proxy models are computationally less complex than existing models, can operate with a reduced number of input variables, and can be used in place of complex models in a variety of applications, such as for modeling credit and underwriting risks. The system includes a specially-programmed, proxy model development computer system and a plurality of computer models including a complex model, a simple model, and a proxy model each of which are trained and evaluated by the computer system. When performance of the proxy model is determined by the computer system to outperform performance of the simple model, and when performance of the proxy model approximates performance of the complex model, the system declares the proxy model sufficient for use in place of the complex model.

### BRIEF DESCRIPTION OF THE DRAWINGS

The foregoing features of the present disclosure will be apparent from the following Detailed Description of the Invention, taken in connection with the accompanying drawings, in which:

FIG. 1 is a diagram illustrating the system of the present disclosure;

FIG. 2 is a flowchart showing processing steps carried out by the system to develop a proxy model;

FIG. 3 is a diagram illustrating hardware and software components of the system of the present disclosure;

FIG. 4 is a table illustrating performance characteristics of a proxy model developed by the system of the present disclosure; and

FIG. 5 is a graph illustrating performance of a proxy model developed by the system of the present disclosure.

### DETAILED DESCRIPTION OF THE INVENTION

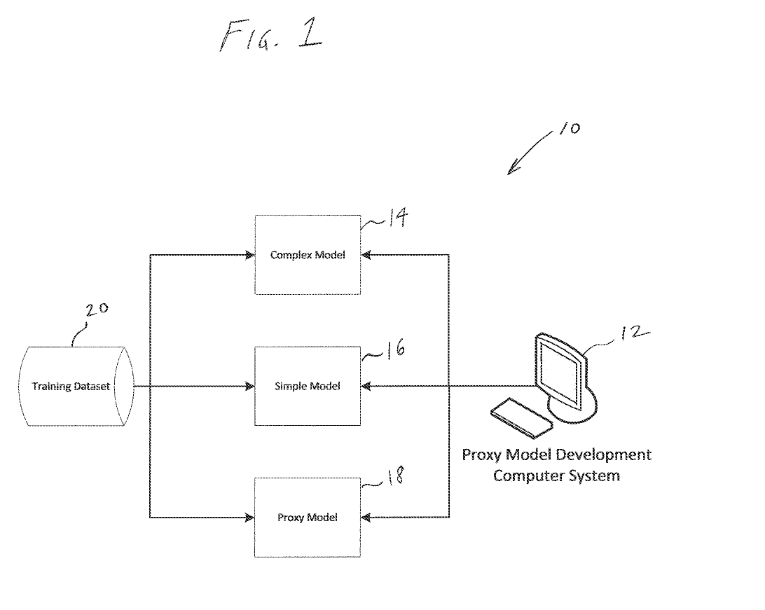

The present disclosure relates to a system and method for developing proxy models, as discussed in detail below in connection with FIGS. 1-5.

The system 10 includes a specially-programmed, proxy model development computer system 12, a plurality of computer models 14-18 including a complex model 14, a simple model 16, and a proxy model 18, and a training data set 20 (e.g., training dataset database). The proxy model 18 is less computationally-complex than the complex model 14, and both the complex model 14 and the simple model 16 are used by the computer system 12 to evaluate performance of the proxy model 18 and suitability for substituting the complex model 14 with the proxy model 18 in future modeling applications. As will be discussed in greater detail below, the computer system 12 trains the models 14-18 using training data in the training data set 20 (which could be stored on the computer system 12 or located remotely therefrom), and evaluates performance of each of the models 14-18. If the computer system 12 determines that the proxy model 18 meets or exceeds pre-defined performance criteria with respect to the complex model 14 and the simple model 16, the computer system 12 declares (e.g., communicates or displays to a user) the proxy model 18 sufficient for use in place of the complex model 14 (and/or automatically substitutes the complex model 14 with the proxy model 18).

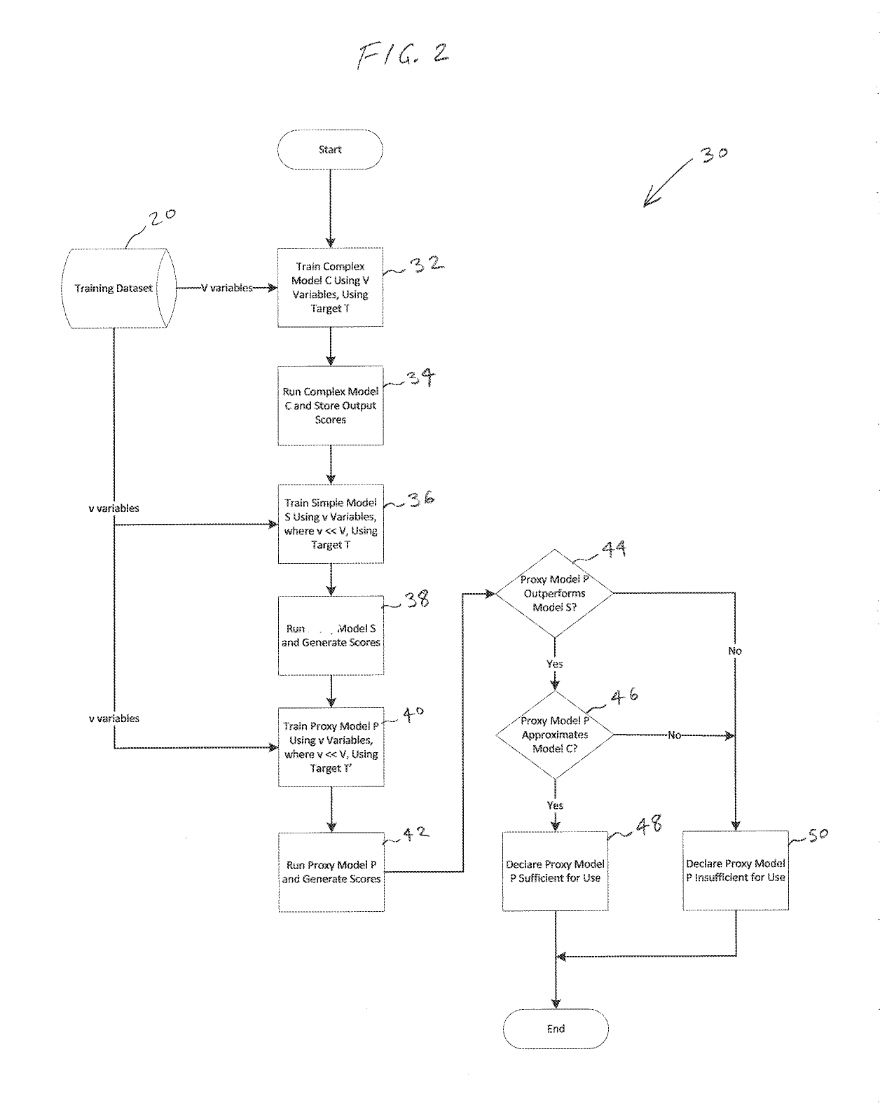

FIG. 2 is a flowchart showing processing steps 30 carried out by the system 10 of the present disclosure. Beginning in step 32, the system trains a complex computer model C (e.g., the complex model 14 of FIG. 1) using a set of variables V from the training dataset 20, and a target T. The target T represents a target performance level for the computer model C, and can be expressed as a numeric score. Then, in step 34, the system executes (runs) the complex model C, scores performance of the model C, and stores the performance score as score T′ (which is utilized by the system in subsequent processing steps discussed hereinbelow). Thereafter, in step 36, the system trains a simple model S (e.g., the simple model 16 of FIG. 1) using a subset of variables v from the training dataset 20 (where v<<V) and the same target T used by the complex model C. Importantly, the subset v of variables is much less than the set of variables V used to train the complex model C. In step 38, the system runs the simple model S and generates one or more performance scores which are then stored by the system. Then, in step 40, the system trains a proxy model P (e.g., the proxy model 16 of FIG. 1) using the same subset of variables v used to train the simple model S, where v<<V, and the target T′ generated previously and based on performance of the complex model T′. Then, in step 42, the system runs the proxy model P and generates performance scores which are then stored by the system.

In step 44, a determination is made as to whether the proxy model P outperforms the model S. This determination is made using the performance scores associated with models P and S. If a negative determination is made, step 50 occurs, wherein the system declares the proxy model P insufficient for use in place of the complex model C. Alternatively, if a positive determination is made in step 44, a second determination is made in step 46, wherein the system determines whether the proxy model P approximates model C. This determination is made using the performance scores associated with models P and C, and a suitable approximation test algorithm, such as the known Kolmogorov-Smirnoff (KS) test. If a negative determination is made, step 50 occurs, wherein the system declares the proxy model P insufficient for use in place of model C. Otherwise, if a positive determination is made in step 46, the system declares proxy model P sufficient for use in place of the complex model C. Thereafter, processing ends.

Although the foregoing description includes discussion of a simple model S, it is noted such a model is not required by the system. In other words, the proxy model could be developed straight from the complex model, such that the simple model would not be required. In such a circumstance, the complex model and proxy model would be trained, and scores for each calculated, as indicated above. Thereafter, using these scores, the system could determine whether the proxy model is suitable for substitution with the complex model.

It is noted that the proxy models, once developed and tested by the system could be used to discern reason codes (e.g., explanations) for model predictions, and/or for regulatory compliance. A reason code is an analytic code (e.g., numeric indicator) that indicates why a particular action/event occurred. An application of the proxy models developed can be used to generate a reason code. It is noted that the output of each of the models could be a number for each training observation (e.g., predicted probability of default).

It is noted that the system 10 could be used in connection with models of various types, such as ensemble models, random forest models, neural network models, etc. Additionally, both the proxy model P and simple model S discussed above could be simple linear models, and the complex model C could be a complex, non-linear model. Further, the proxy model development processes carried out by the system 10 could be described algorithmically as follows:

1. Assume there is a dataset with N training records and V variables, and there is a need to train a linear (simple) model with at most v variables (v<<V).

2. Train a more complex model that uses all the V variables and has much higher performance compared to the simple model, and call the vector containing the output scores of this model on the training set as T′ (N×1). This complex model can be an ensemble model of a variety of models with different variables. This model usually provides high performance since it has no constraints.

3. Train the simple linear model using only v variables, but replace the original target with T′.

By simply changing the target when training the model, a high-performance model is obtained while satisfying associated production constraints. This is achieved by leveraging the good performance of a complicated model with minor or no constraints, to produce the target for the proxy model.

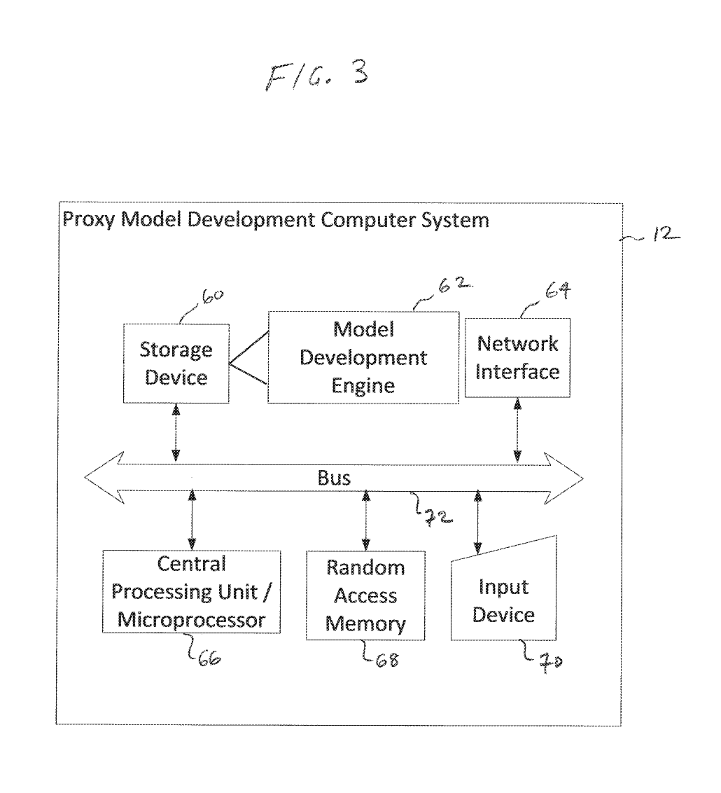

FIG. 3 is a diagram illustrating hardware and software components of the proxy model development computer system 12. The computer system 12 can be any desired computer system, such as a stand-alone computer system, a server, a personal computer, a laptop computer, a tablet computer, a smart cellular phone, or any other desired computing device. The processing steps 30 shown in FIG. 2 could be embodied as computer-readable program code that can be executed by the computer system 12. The system could be embodied as a model development software engine 62 which is stored in a storage device 60 of the computer system 12 and executed by a central processing unit (CPU) (e.g., microprocessor) 66. Additionally, the computer system 12 could include a network interface 62, a random access memory 68, one or more input and/or output devices 70 (e.g., keyboard, display, mouse, touch screen, etc.) and a bus 72 which interconnects each of the foregoing components. The storage device 60 could comprise any suitable, non-transitory, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). Moreover, the engine 62 could be programmed using any suitable, high or low level computing language, such as Java, C, C++, C#, .NET, SAS, SPSS, etc. The network interface 64 could include an Ethernet network interface device, a wireless network interface device, or any other suitable device which permits the computer system 12 to communicate via a network. The CPU 66 could include any suitable single- or multiple-core microprocessor of any suitable architecture that is capable of executing the model development engine 62 (e.g., INTEL microprocessor, ARM microprocessor, etc). The random access memory 68 could include any suitable, high-speed, random access memory typical of most modern computers, such as dynamic RAM (DRAM), etc.

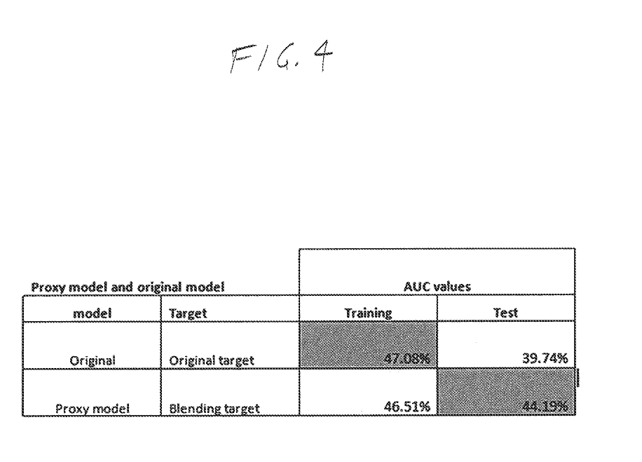

FIG. 4 is a table illustrating performance characteristics of a proxy model developed by the system of the present disclosure. In this example, two models were compared with the same set of variables: one trained by the original target, and the other (proxy) trained by a blending target. The training method was simple logistic regression applied to both models. The evaluation is based on the original target. The results show that proxy model achieves much better performance. Model performance is compared based on Area Under Receiver Operating Characteristic (ROC) Curve (AUC) information. AUC can be represented as a value between zero to one, and higher AUC values represent that a particular model is performing better than other models. ROC curves are created by plotting the true positive rate against the false positive rate to illustrate the performance of the binary classifier.

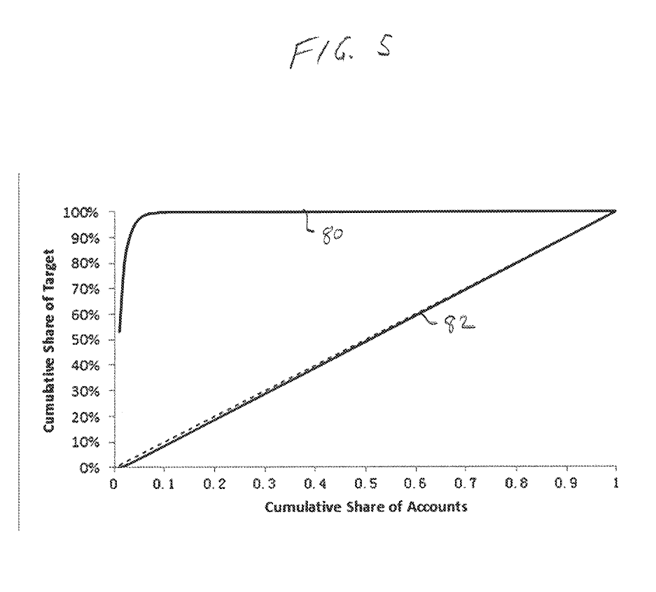

FIG. 5 is a graph illustrating performance of a proxy model developed by the system of the present disclosure. In this example, a proxy model was trained based on an ensemble score. The training method was simple logistic regression. The evaluation is based on the ensemble score to show how well a proxy model can simulate a complex ensemble model. The results show that the proxy model scores are highly correlated with the original ensemble model scores, with KS of about 0.94 on the interested group. Each point on the plot represents a threshold value between 0 to 1, and the vertical axis represents the percentage of a specific population which scored higher than the threshold at that point. The horizontal axis represents the percentage for the overall population. Line 80 represents the percentage of the target equal to 1 population (true positive rate) versus the overall population. Line 82 represents the target equal to 0 population (false positive rate) versus the overall population.

As discussed above, the system of the present disclosure is useful in connection with credit and risk applications, such as underwriting where a high performance model is needed while satisfying constraints such as limited number of variables and clear reason codes. However, the system can be used in other applications, such as in any data mining problem with constraints on the model complexity and variable counts, or if a reason code is needed for the final predictions of the model. Further, credit card applicants, insurance applicants, loan applicants, market consumers, and collection agencies can utilize the system of the present disclosure to develop proxy models for use in these fields. Indeed, credit card issuers generally require high-performance simple linear models to comply with constraints such as law enforcements, internal rules, and high score reasons. Credit bureaus have similar requirements in production. As such, the system of the present disclosure can provide benefits to these entities by introducing a better model. Further, collection agencies can use the system to create a better policy, and insurance companies can adjust their pricing policies using the system. Moreover, general marketing analysts can utilize the system to generate better-explained models with improved performance.

Having thus described the system of the present disclosure in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the present disclosure. What is desired to be protected is set forth in the following claims.

What is claimed is:

1. A system for developing proxy models comprising:
a proxy model development computer system in electronic communication with a training database storing training data therein; and
a plurality of computer models including a complex model and a proxy model, each of the plurality of computer models trained by the computer system using the training data from the training database,
wherein the computer system evaluates performance of each of the plurality of computer models and, if the computer system determines that the proxy model meets pre-defined performance criteria and approximates performance of the complex model, then the computer system communicates to a user that the proxy model can be substituted for the complex model.

2. The system of claim 1, wherein the computer system trains the complex model using the training data and a target numeric score representing a target performance level.

3. The system of claim 2, wherein the computer system executes the complex model to generate a complex model score.

4. The system of claim 3, wherein the computer system trains a simple model using the training data and the target numeric score.

5. The system of claim 4, wherein the computer system executes the simple model to generate a simple model score.

6. The system of claim 5, wherein the computer system trains the proxy model using the training data and the complex model score.

7. The system of claim 6, wherein the computer system executes the proxy model to generate a proxy model score.

8. The system of claim 7, wherein the computer system determines whether to substitute the complex model with the proxy model by determining whether the proxy model approximates the complex model using an approximation test algorithm.

9. The system of claim 8, wherein the approximation test algorithm is the Kolmogorov-Smirnoff test.

10. The system of claim 1, wherein the training data used to train the complex model is a set of variables, and the training data used to train the proxy model is a subset of variables less than the set of variables.

11. The system of claim 1, wherein the proxy model is used to discern reason codes for model predictions.

12. A method for developing proxy models, comprising the steps of:
electronically communicating by a proxy model development computer system with a training database storing training data therein;
training by the computer system a plurality of computer models including a complex model and a proxy model using the training data from the training database;
evaluating, by the computer system, performance of each of the plurality of computer models;
determining whether the proxy model at least meets pre-defined performance criteria and whether the proxy model approximates performance of the complex model; and
communicating to a user that the proxy model can be substituted for the complex model if the proxy model meets the pre-defined performance criteria and approximates performance of the complex model.

13. The method of claim 12, wherein the computer system trains the complex model using the training data and a target numeric score representing a target performance level.

14. The method of claim 13, further comprising executing the complex model to generate a complex model score.

15. The method of claim 14, wherein the computer system trains a simple model using the training data and the target numeric score.

16. The method of claim 15, further comprising executing the simple model to generate a simple model score.

17. The method of claim 16, wherein the computer system trains the proxy model using the training data and the complex model score.

18. The method of claim 17, further comprising executing the proxy model to generate a proxy model score.

19. The method of claim 18, wherein the computer system determines whether to substitute the complex model with the proxy model by determining whether the proxy model approximates the complex model using an approximation test algorithm.

20. The method of claim 19, wherein the approximation test algorithm is the Kolmogorov-Smirnoff test.

21. The method of claim 12, wherein the training data used to train the complex model is a set of variables, and the training data used to train the proxy model is a subset of variables less than the set of variables.

22. The method of claim 12, further comprising executing the proxy model to discern reason codes for model predictions.

23. A computer-readable medium having computer-readable instructions stored thereon which, when executed by a computer system, cause the computer system to perform the steps of:
electronically communicating by a proxy model development computer system with a training database storing training data therein;
training by the computer system a plurality of computer models including a complex model and a proxy model using the training data from the training database;
evaluating, by the computer system, performance of each of the plurality of computer models;
determining whether the proxy model at least meets pre-defined performance criteria and whether the proxy model approximates performance of the complex model; and
communicating to a user that the proxy model can be substituted for the complex model if the proxy model meets the pre-defined performance criteria and approximates performance of the complex model.

24. The computer-readable medium of claim 23, wherein the computer system trains the complex model using the training data and a target numeric score representing a target performance level.

25. The computer-readable medium of claim 24, further comprising executing the complex model to generate a complex model score.

26. The computer-readable medium of claim 25, wherein the computer system trains a simple model using the training data and the target numeric score.

27. The computer-readable medium of claim 26, further comprising executing the simple model to generate a simple model score.

28. The computer-readable medium of claim 27, wherein the computer system trains the proxy model using the training data and the complex model score.

29. The computer-readable medium of claim 28, further comprising executing the proxy model to generate a proxy model score.

30. The computer-readable medium of claim 29, wherein the computer system determines whether to substitute the complex model with the proxy model by determining whether the proxy model approximates the complex model using an approximation test algorithm.

31. The computer-readable medium of claim 30, wherein the approximation test algorithm is the Kolmogorov-Smirnoff test.

32. The computer-readable medium of claim 23, wherein the training data used to train the complex model is a set of variables, and the training data used to train the proxy model is a subset of variables less than the set of variables.

33. The computer-readable medium of claim 23, further comprising executing the proxy model to discern reason codes for model predictions.
